(19) United States
(12) Patent Application Publication
(10) Pub. No.: US 2013/0199655 A1
(43) Pub. Date: Aug. 8, 2013

(54) WATER-PERMEABLE PIPE AND METHOD FOR MANUFACTURING THE SAME

(71) Applicants: Shu-Nu LEE, Min Hsiung Township (TW); Ying-Hsuan WU, Min Hsiung Township (TW)

(72) Inventors: Shu-Nu LEE, Min Hsiung Township (TW); Ying-Hsuan WU, Min Hsiung Township (TW)

(21) Appl. No.: 13/607,092

(22) Filed: Sep. 7, 2012

(30) Foreign Application Priority Data
Feb. 3, 2012 (TW) 101103588

(51) Int. Cl. F16L 9/14; D05B 11/00

(52) U.S. Cl. 138/137; 112/475.08

(57) ABSTRACT

A water-permeable pipe includes inner and outer tubular units cooperatively defining an outer passage therebetween. Each tubular unit includes a water-permeable outer layer coated with a waterproof inner layer, two end portions, and an interconnecting member including a plurality of spaced apart joints that interconnect the end portions. The end portions of the inner tubular unit are diametrically opposite to the end portions of the outer tubular unit. Each adjacent pair of the joints define an interstice therebetween that permits water to flow therethrough and that fluidly communicates an inner passage in the inner tubular unit and the outer passage, and the outer passage and an external environment, respectively.

### CROSS-REFERENCE TO RELATED APPLICATION

This application claims priority of Taiwanese Patent application no. 101103588, filed on Feb. 3, 2012.

### BACKGROUND OF THE INVENTION

1. Field of the Invention

The invention relates to a water-permeable pipe and method for manufacturing the same, more particularly to a foldable water-permeable pipe.

2. Description of the Related Art

A conventional water-permeable pipe disclosed in Taiwanese Patent Publication No. M277256 includes an inner tube formed with a plurality of through holes and an outer layer sleeved on the inner tube. The inner tube is made of a rigid material such as plastic (e.g., polyvinyl chloride (PVC)) or metal (e.g., copper or iron), and the outer layer is made of a foam material that is water permeable.

The conventional water-permeable pipe is adapted to be buried under the ground where plants are cultivated, and water may flow from the inner tube to the outer layer via the through holes and permeate through the outer layer so as to irrigate the plants.

However, since the inner tube is made of a rigid material, which is not foldable, the conventional water-permeable pipe occupies a relatively large area when not in use. Furthermore, it is inconvenient to recycle the conventional water-permeable pipe since the inner tube and the outer layer are made of different materials. Additionally, when the inner tube is made of PVC, service life of the conventional water-permeable pipe is relatively short under low temperature, e.g., subzero temperature, since PVC may become embrittle.

Moreover, when the inner tube is made of a flexible plastic material, water may be unable to flow through a portion where the conventional water-permeable pipe is bent or pressed. SUMMARY OF THE INVENTION

Therefore, the object of the present invention is to provide a water-permeable pipe capable of alleviating the above drawbacks of the prior art.

According to the present invention, a water-permeable pipe comprises a pair of tubular units surrounding an axis and extending in an axial direction along the axis. An outer one of the tubular units is sleeved on an inner one of the tubular units. The tubular units cooperatively define an outer passage therebetween. The inner one of the tubular units defines an inner passage therein. Each of the tubular units includes a water-permeable outer layer having an inner surface, a waterproof inner layer intimately connected to the inner surface or the outer layer to form a layer assembly, two end portions parallel to the axis and extending outwardly from the layer assembly, and an interconnecting member including a plurality of spaced apart joints that interconnect the end portions and that are disposed along the axial direction. The end portions of one of the tubular units are diametrically opposite to the end portions of the other one of the tubular units. Each adjacent pair of the joints of the interconnecting member define an interstice therebetween. The interstice formed at the interconnecting member of the outer one of the tubular units is in fluid communication with the outer passage and an external environment, and the interstice formed at the interconnecting member of the inner one of the tubular units is in fluid communication with the inner passage and the outer passage.

According to another aspect of the present invention, a method for manufacturing a water-permeable pipe comprises the following steps of:

a) coating a waterproof layer on a water-permeable layer to form a layer assembly having two opposite end portions;

b) folding the layer assembly and interconnecting the end portions of the layer assembly by sewing using a thread to form a tubular unit that includes a water-permeable outer layer and a waterproof inner layer, the waterproof layer coated in step a) serving as the waterproof inner layer of the tubular unit, the water-permeable layer serving as the water-permeable outer layer of the tubular unit;

c) repeating steps a) and b) to form another tubular unit; and

d) sleeving one of the tubular units made in steps b) and c) on the other one of the tubular units to form a water-permeable pipe, in which the end portions of said one of the tubular units are diametrically opposite to the end portions of said other one of the tubular units.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary exploded perspective view of a first preferred embodiment of a water-permeable pipe according to the present invention;

FIG. 2 is a sectional view of the first preferred embodiment;

FIG. 3 is a flow chart illustrating a method of manufacturing the water-permeable pipe of the first preferred embodiment;

FIG. 4 is a schematic diagram illustrating consecutive steps of the method of manufacturing the water-permeable pipe;

FIG. 5 is a sectional view of a second preferred embodiment of the water-permeable pipe according to the present invention; and

FIG. 6 is a sectional vies of a third preferred embodiment of the water-permeable pipe according to the present invention.

### DETAILED DESCRIPTION OF THE PREFERRED EMBODIMENTS

Before the present invention is described in greater detail, it should be noted that same reference numerals have been used to denote like elements throughout the specification.

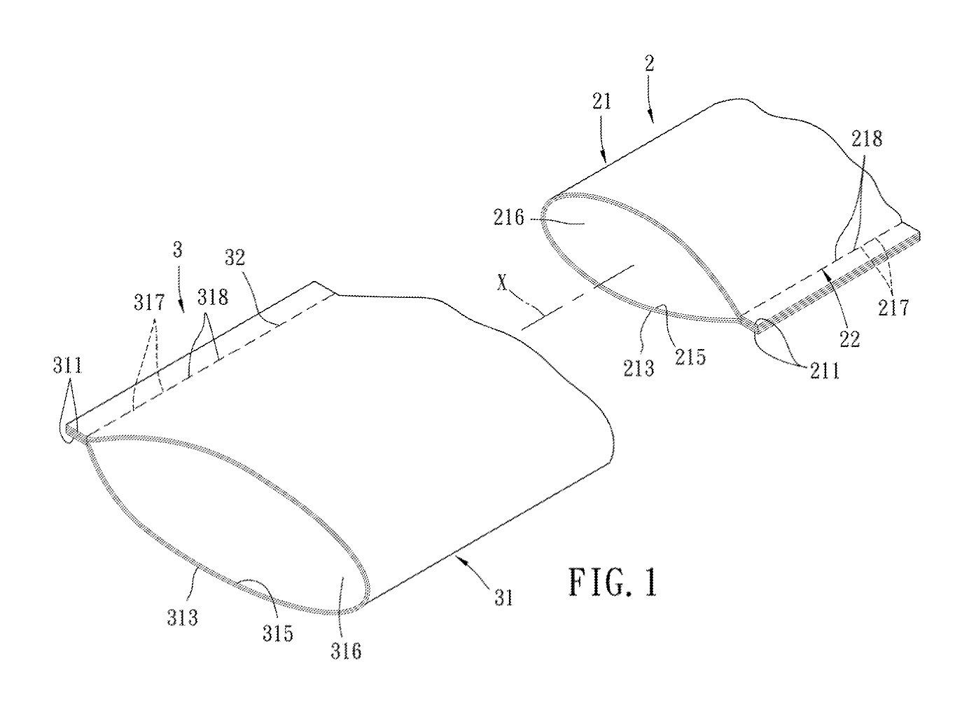

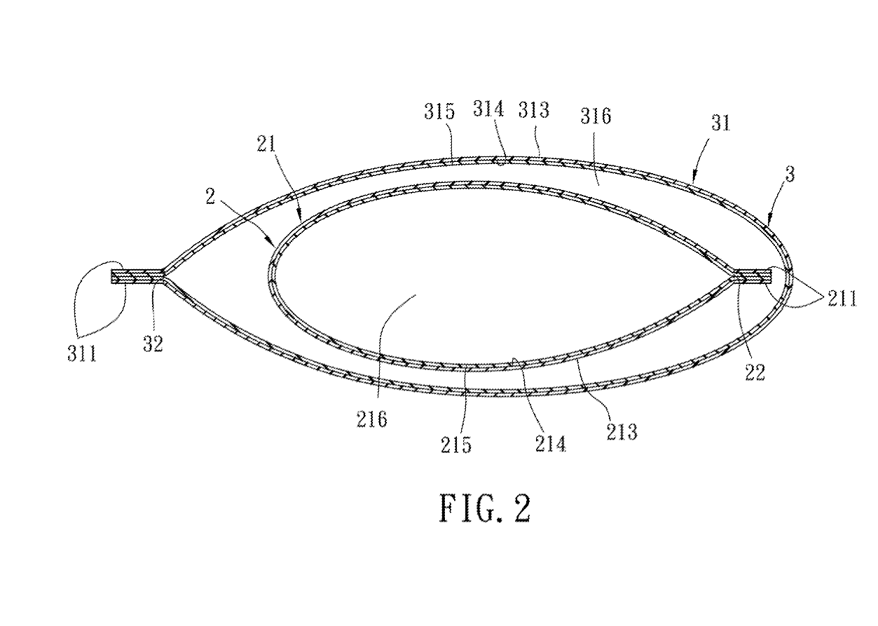

Referring to FIGS. 1 and 2, a first preferred embodiment of a water-permeable pipe according to the present invention is shown. The water-permeable pipe comprises a pair of tubular units 2, 3 surrounding an axis (X) and extending in an axial direction along the axis (X). An outer one of the tubular units 3 is sleeved on an inner one of the tubular units 2. The tubular units 2, 3 cooperatively define an outer passage 316 therebetween, and the inner one of the tubular units 2 defines an inner passage 216 therein.

Each of the tubular units 2, 3 includes a water-permeable outer layer 213, 313 having an inner surface 214, 314, a waterproof inner layer 215, 315 intimately connected to the inner surface 214, 314 of the outer layer 213, 313 to form a layer assembly 21, 31, two end portions 211, 311 parallel to the axis (X) and extending outwardly from the layer assembly 21, 31, and an interconnecting member 22, 32 including a plurality of spaced apart joints 218, 318 that interconnect the end portions 211, 311 and that are disposed along the axial direction. The water-permeable outer layer 213, 313 and the waterproof inner layer 215, 315 of each of the tabular units 2, 3 are made of the same material, particularly polyester fiber (PES) in this embodiment.

Each adjacent pair of the joints 218, 318 of the interconnecting member 22, 32 define an interstice 217, 31 therebetween. The interstice 317 formed at the interconnecting member 32 of the outer one of the tubular units 3 is in fluid communication with the outer passage 316 and an external environment, and the interstice 217 formed at the interconnecting member 22 of the inner one of the tubular units 2 is in fluid communication with the inner passage 216 and the outer passage 316. In this embodiment, the interconnecting member 22, 32 of each of the tubular units 2, 3 is a thread interconnecting the end portions 211, 311 of a respective one of the tubular units 2, 3 by sewing. It should be noted that the dimension of the interstice 217, 317 between each adjacent pair of the joints 218, 318 depends on the stitch density of the thread and can be adjusted as desired.

The water-permeable pipe is adapted to be disposed on or buried under the ground, where plants are cultivated, for watering the plants. In order to water the plants using the water-permeable pipe, the inner passage 216 is first filled with water, and then the water in the inner passage 216 flows through the interstices 217 to the outer passage 316. Thereafter, the water flows out of the cuter passage 316 via the interstices 317 and permeates through the water-permeable outer layer 313 so as to water the plants.

Preferably, the end portions 211 of the inner one of the tubular units 2 are diametrically opposite to the end portions 311 of the outer one of the tabular units 3. By such configuration, the water can be delivered to a distal end of the water-permeable pipe since the outer one of the tubular units 3 may drain the water after the outer passage 316 is filled with water.

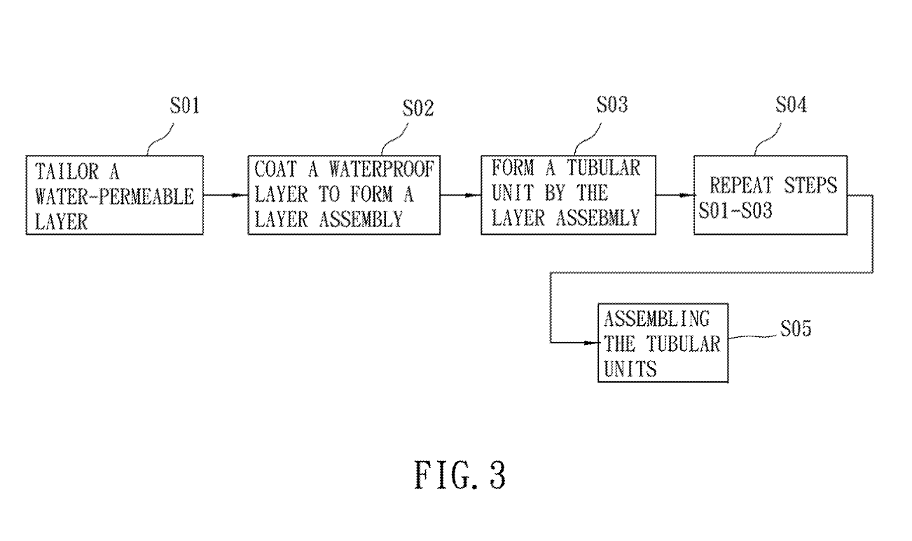

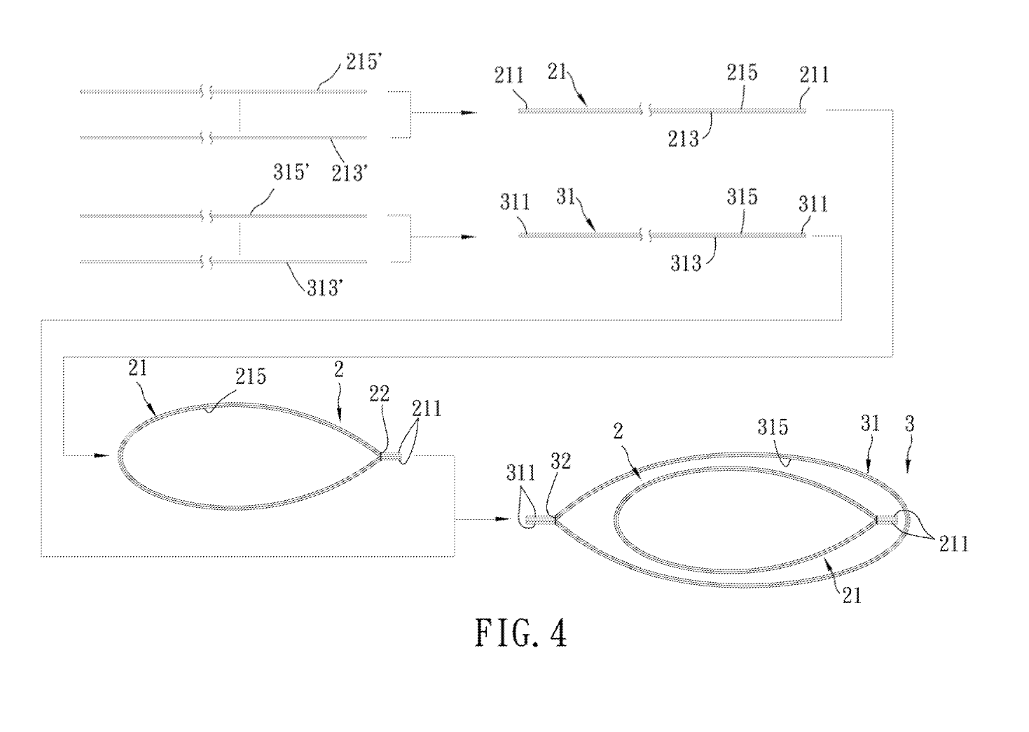

Referring to FIGS. 3 and 4, a method for manufacturing the water-permeable pipe of the first preferred embodiment comprises the following steps. In step S01, a water-permeable layer 213′, 313′ is tailored. In step S02, a waterproof layer 215′, 315′ is coated on the water-permeable layer 213′, 313′ to form, a layer assembly 21, 31 having two opposite end portions 211, 311. In step S03, the layer assembly 21, 31 is folded and. interconnected at the end portions 211, 311 of the layer assembly 21, 31 by sewing using a thread, i.e., the interconnecting member 22, 32, so as to form a tubular unit 2, 3 that includes a water-permeable outer layer 213, 313 and a waterproof inner layer 215, 315. The waterproof layer 215′, 315′ coated in step S02 serves as the waterproof inner layer 215, 315 of the tubular unit 2, 3, and the water-permeable layer 213′, 313′ serves as the water-permeable outer layer 213, 313 of the tubular unit 2, 3.

In step S04, steps S01 to S03 are repeated to form another tubular unit 2, 3. Alternatively, in other embodiments, two tubular units 2, 3 can be manufactured at the same time. Subsequently, in step S05, an outer one of the tubular units 3 made in step S04, which has an inner diameter greater than an outer diameter of an inner one of the tubular units 2, is sleeved on the inner one of the tubular units 2 to form a water-permeable pipe. In particular, the end portions 211 of the inner one of the tubular units 2 are diametrically opposite to the end portions 311 of the outer one of the tubular limits 3. It should be noted that steps S01 and S02 are interchangeable.

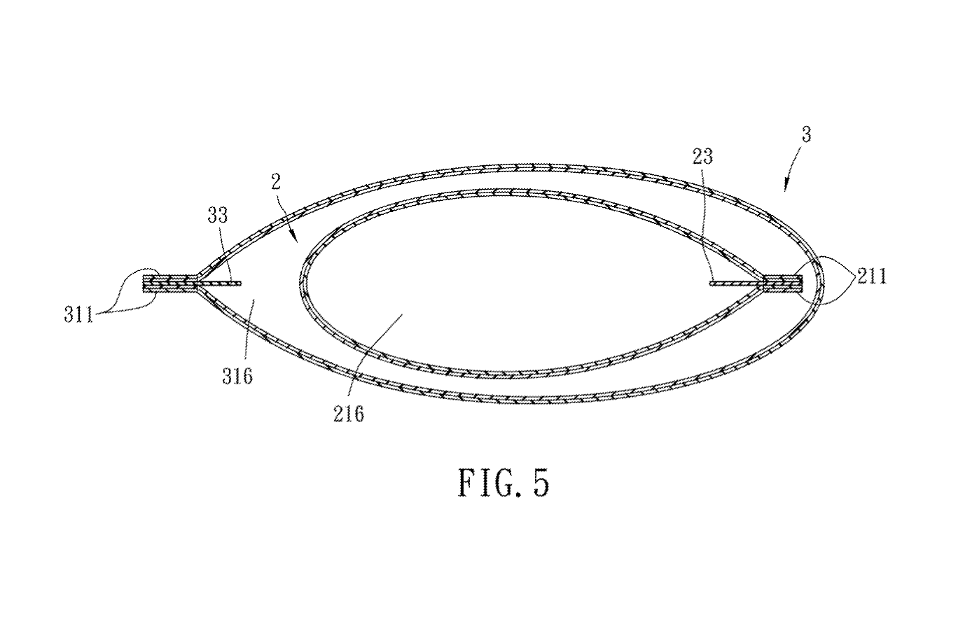

Referring to FIG. 5, a second preferred embodiment of the water-permeable pipe is shown. In the second preferred embodiment, each of the tubular units 2, 3 further includes an insert 23, 33. The insert 23 of the inner one of the tubular units 2 is interposed between the end portions 211 and extends into the inner passage 216. The insert 33 of the outer one of the tubular units 3 is interposed between the end portions 311 and extends into the outer passage 316. The insert 23, 33 of each of the tubular units 2, 3 is a strip sandwiched between the end portions 211, 311 of the respective one of the tabular units 2, 3 and has a uniform thickness.

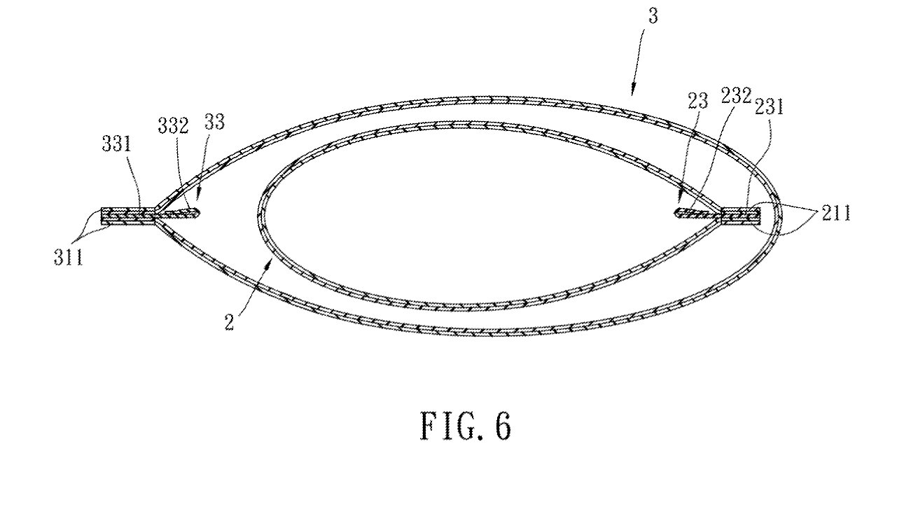

Referring to FIG. 6, the third preferred embodiment of the water-permeable pipe is shown. The third preferred embodiment is similar to the second preferred embodiment. In this embodiment, the insert 23 of the inner one of the tubular units 2 includes a sandwiched portion 231 sandwiched between the end portions 211, and an expanded portion 232 extending inwardly from the sandwiched portion 231 and having a cross-sectional dimension greater than that of the sandwiched portion 231. Similarly, the insert 33 of the outer one of the tubular units 3 includes a sandwiched portion 331 sandwiched between the end portions 311, and an expanded portion 332 extending inwardly from the sandwiched portion 331 and having a cross-sectional dimension greater than that of the sandwiched portion 331.

It should be noted that, in the second and third preferred embodiments, the dimension of the interstice 217, 317 between each adjacent pair of the joints 218, 318 is increased as a result of interposition of the insert 22, 33. By this way, water can still flow through the interstices 217, 317 when a portion of the water-permeable pipe is bent or compressed.

The method for manufacturing the water-permeable pipe of the second and third preferred embodiments further comprises, prior to step 803, the step of tailoring out a strip that serves as the insert 23, 33. After folding the layer assembly 21, 31 and before interconnecting the end portions 211, 311 of the layer assembly 21, 31, the strip is interposed between the end portions 211, 311 of the layer assembly 21, 31, Thereafter, the subsequent steps S04 to S05 are performed to complete the water-permeable pipe.

To sum up, the advantages of the present invention are as follows. In the present invention, the water-permeable pipe can be bent since the tubular units 2, 3 are made of flexible plastic material, such that it is convenient to store the water-permeable pipe. Further, the water-permeable outer layer 213, 313 and the waterproof inner layer 215, 315 of each of the tubular units 2, 3 are made of the same material, and thus, it is relatively simple to recycle the water-permeable pipe of the present invention. Additionally, service life of the water-permeable pipe can foe prolonged since the polyester material may not become embrittle under low temperature, e.g., subzero temperature. Moreover, by virtue of the inserts 23, 33, the interstices 217, 317 are enlarged, and thus, the water-permeable pipe may not be obstructed and the inner passage 216 and the outer passage 316 may still be filled with water even when the water-permeable pipe is bent or pressed. As a result, the water-permeable pipe can water the plants uniformly.

While the invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A water-permeable pipe comprising:
a pair of tubular units surrounding an axis and extending in an axial direction along the axis, an outer one of said tubular units being sleeved on an inner one of said tubular units, said tubular units cooperatively defining an outer passage therebetween, said inner one of said tubular units defining an inner passage therein, each of said tubular units including
a water-permeable outer layer having an inner surface,
a waterproof inner layer intimately connected to said inner surface of said outer layer to form a layer assembly,
two end portions parallel to the axis, extending outwardly from said layer assembly, and connected to each other, said end portions of one of said tubular units being diametrically opposite to said end portions of the other one of said tubular units, and
an interconnecting member including a plurality of spaced apart joints that interconnect said end portions and that are disposed along the axial direction, each adjacent pair of said joints of said interconnecting member defining an interstice therebetween, said interstice formed at said interconnecting member of said outer one of said tubular units being in fluid communication with said outer passage and an external environment, said interstice formed at said interconnecting member of said inner one of said tubular units being in fluid communication with said inner passage and said outer passage.

2. The water-permeable pipe as claimed in claim 1, wherein each of said tubular units includes an insert interposed between said end portions thereof and extending into a respective one of said inner passage and said outer passage.

3. The water-permeable pipe as claimed in claim 2, wherein said insert of each of said tubular units is a strip sandwiched between said end portions of the respective one of said tubular units and having a uniform thickness.

4. The water-permeable pipe as claimed in claim 2, wherein said insert of each of said tubular units includes a sandwiched pert ion sandwiched between said end portions of the respective one of said tubular units and an expanded portion extending inwardly from said sandwiched portion and having a cross-sectional dimension greater than that of said sandwiched portion.

5. The water-permeable pipe as claimed in claim 1, wherein said water-permeable outer layer and said waterproof inner layer of each of said tubular units are made of same material.

6. The water-permeable pipe as claimed in claim 1, wherein said water-permeable cuter layer and said waterproof inner layer of each of said tubular units are made of polyester fiber.

7. The water-permeable pipe as claimed in claim 1, wherein said interconnecting member of each of said tubular units is a thread interconnecting said end portions of a respective one of said tubular units by sewing.

8. A method for manufacturing a water-permeable pipes comprising the following steps of:
a) coating a waterproof layer on a water-permeable layer to form a layer assembly having two opposite end portions;
b) folding the layer assembly and interconnecting the end portions of the layer assembly by sewing using a thread to form a tubular unit that includes a water-permeable outer layer and a waterproof inner layer, the waterproof layer coated in step a) serving as the waterproof inner layer of the tubular unit, the water-permeable layer serving as the water-permeable outer layer of the tubular unit;
c) repeating steps a) and b) to form another tubular unit; and
d) sleeving one of the tubular units made in steps b) and c) on the other one of the tubular units to form a water-permeable pipe, in which the end portions of said one of the tubular units are diametrically opposite to the end portions of said other one of the tubular units.

9. The method as claimed in claim 8, further comprising, prior to step a), the step of tailoring out the water-permeable layer.

10. The method as claimed in claim 9, further comprising, prior to step b), the step of tailoring a strip;
wherein, in step b), after folding the layer assembly and before interconnecting the end portions of the layer assembly, the strip is interposed between the end portions of the layer assembly and serves as an insert.
